(19) United States
(12) Patent Application Publication
(10) Pub. No.: US 2024/0363913 A1
(43) Pub. Date: Oct. 31, 2024

(54) ACCESSORY COMPONENT INDICATING FEATURES FOR VISUALLY IDENTIFYING PROPER ASSEMBLY TO A SEALED ENCLOSURE

(71) Applicant: FORD GLOBAL TECHNOLOGIES, LLC, Dearborn, MI (US)

(72) Inventors: Samuel Jeffrey TOMLINSON, Farmington Hills, MI (US); Nathaniel CONTI, Canton, MI (US); Robert Harless KALINSKI, Royal Oak, MI (US)

(21) Appl. No.: 18/306,499

(22) Filed: Apr. 25, 2023

(51) Int. Cl. H01M 10/48; B60L 50/64; H01M 50/342

(52) U.S. Cl. CPC H01M 10/488; B60L 50/64; H01M 50/3425; H01M 2220/20

(57) ABSTRACT

An accessory component may be secured to a sealed enclosure to provide an assembly. The accessory component may include one or more indicator tabs. The one or more indicator tabs may be configured to flex between a first position and a second position. In the second position, the indicator tabs may provide a visual indication that the accessory component is properly assembled relative to the sealed enclosure.

### TECHNICAL FIELD

This disclosure relates generally to the attachment of accessory components to a sealed enclosure, and more particularly to accessory components that are equipped with indicating features for visually identifying proper assembly of the accessory component to the sealed enclosure.

### BACKGROUND

Many components, such as traction battery packs, for example, require a gas-tight enclosure. Attachment of accessory components to the gas-tight enclosure typically requires various sealing arrangements.

### SUMMARY

An assembly according to an exemplary aspect of the present disclosure includes, among other things, a sealed enclosure, and an accessory component received within an opening formed through a wall of the sealed enclosure. An indicator tab of the accessory component is configured to flex between a first position and a second position for providing a visual indication that the accessory component is properly assembled relative to the sealed enclosure.

In a further non-limiting embodiment of the foregoing assembly, the assembly is a traction battery pack.

In a further non-limiting embodiment of either of the forgoing assemblies, the accessory component is a pressure relief valve.

In a further non-limiting embodiment of any of the foregoing assemblies, in the second position, a portion of the indicator tab protrudes outwardly from a front surface of a mounting flange of the accessory component.

In a further non-limiting embodiment of any of the foregoing assemblies, in the first position, the portion does not protrude outwardly from the front surface.

In a further non-limiting embodiment of any of the foregoing assemblies, the indicator tab is configured to flex between the first position and the second position as the accessory component is moved into further engagement with the wall.

In a further non-limiting embodiment of any of the foregoing assemblies, a cam tab of the accessory component is configured to engage a mating flange of the wall to mount the accessory component to the sealed enclosure.

In a further non-limiting embodiment of any of the foregoing assemblies, the cam tab includes an outer plateau, an inner plateau, and an angled surface that connects between the outer plateau and the inner plateau.

In a further non-limiting embodiment of any of the foregoing assemblies, a first thickness of the cam tab at the inner plateau is greater than a second thickness of the cam tab at the outer plateau.

In a further non-limiting embodiment of any of the foregoing assemblies, the accessory component includes a mounting flange having a ring-like protrusion. A seal is received over the ring-like protrusion and is configured to seal against a portion of the wall when the accessory component is fully received within the opening.

An assembly according to another exemplary aspect of the present disclosure includes, among other things, a sealed enclosure, an accessory component received within an opening formed through a wall of the sealed enclosure, a cam tab, and an indicator tab. The cam tab of the accessory component is configured to engage a mating flange of the wall for mounting the accessory component to the sealed enclosure, and the indicator tab of the accessory component is configured to move from a first position to a second position as the cam tab is moved into further engagement relative to the mating flange. The second position provides a visual indication that the accessory component is properly assembled relative to the sealed enclosure.

In a further non-limiting embodiment of the foregoing assembly, the assembly is a traction battery pack, and the accessory component is a pressure relief valve.

In a further non-limiting embodiment of either of the foregoing assemblies, in the second position, a portion of the indicator tab protrudes outwardly from a front surface of a mounting flange of the accessory component to provide the visual indication.

In a further non-limiting embodiment of any of the foregoing assemblies, the front surface faces in a direction away from an interior of the sealed enclosure.

In a further non-limiting embodiment of any of the foregoing assemblies, the cam tab includes an outer plateau, an inner plateau, and an angled surface that connects between the outer plateau and the inner plateau.

In a further non-limiting embodiment of any of the foregoing assemblies, a first thickness of the cam tab at the inner plateau is greater than a second thickness of the cam tab at the outer plateau.

In a further non-limiting embodiment of any of the foregoing assemblies, the accessory component includes a ring-like protrusion that protrudes from a mounting flange.

In a further non-limiting embodiment of any of the foregoing assemblies, a seal is received over the ring-like protrusion, and the seal is configured to seal against a portion of the wall when the cam tab is moved into full engagement relative to the mating flange.

In a further non-limiting embodiment of any of the foregoing assemblies, the seal is a lip seal.

In a further non-limiting embodiment of any of the foregoing assemblies, the indicator tab is connected at one end to a mounting flange of the accessory component to establish a fulcrum about which the indicator tab can flex between the first position and the second position.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates an accessory component that includes indicating features for visually identifying proper assembly of the accessory component relative to a sealed enclosure.

FIG. 2 is a top view of the accessory component of FIG. 1.

FIG. 3 illustrates select portions of the sealed enclosure of FIG. 1.

FIG. 4 is a cross-sectional view through section 4-4 of the accessory component of FIG. 1.

FIG. 5 illustrates a traction battery pack that includes an accessory component attached thereto.

FIG. 6 is a cross-sectional view of the traction battery pack of FIG. 5.

FIG. 7 illustrates an electrified vehicle that includes the traction battery pack of FIGS. 5 and 6.

### DETAILED DESCRIPTION

This disclosure details the attachment of an accessory component to a sealed enclosure. The accessory component may include one or more indicator tabs. The one or more indicator tabs may be configured to flex between a first position and a second position. In the second position, the indicator tabs may provide a visual indication that the accessory component is properly assembled relative to the sealed enclosure. These and other features are discussed in greater detail in the following paragraphs of this detailed description.

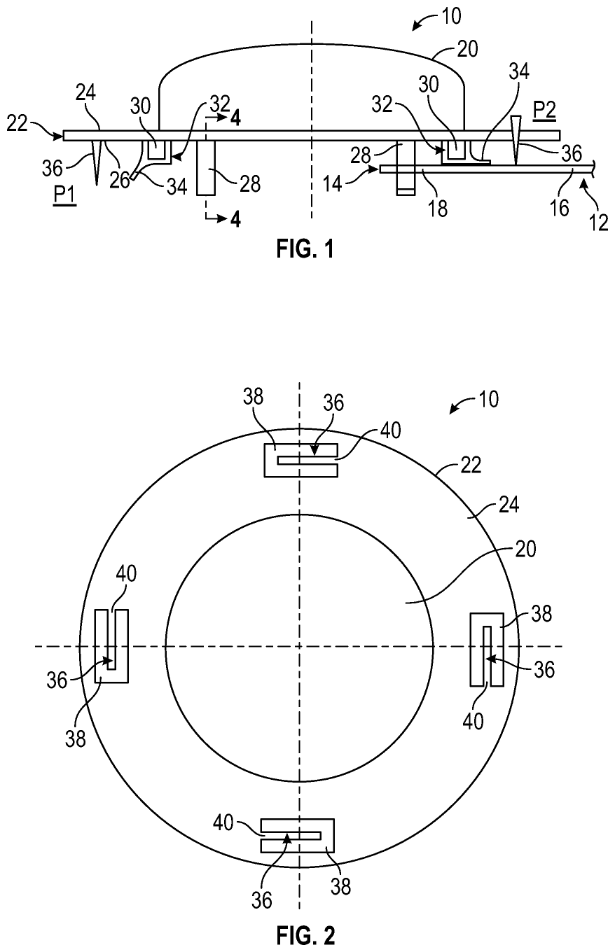

FIGS. 1 and 2 illustrate an accessory component 10 that may be mounted to a sealed enclosure 12 to establish an assembly. For simplicity, a cross-section of the accessory component 10 is shown in an assembled state relative to the sealed enclosure 12 on the right hand side of FIG. 1 and is shown in an unassembled state relative to the sealed enclosure 12 on the left hand side of FIG. 1. FIG. 2 is a top view and illustrates the accessory component 10 in the unassembled state (e.g., removed from the sealed enclosure 12).

The accessory component 10 could be a valve or any other type of component that is attachable to the sealed enclosure 12 and configured for performing a specific function associated with the sealed enclosure 12. The sealed enclosure 12 could establish an outer housing of an automotive component, a medical component, or any other type of component that requires a sealed enclosure.

Although a single accessory component 10 is shown relative to the sealed enclosure 12 in the illustrated embodiments, a greater number of accessory components 10 could be provided within the scope of this disclosure. In an embodiment, the accessory component 10 includes a twist-in-place design. In another embodiment, the accessory component 10 includes a press-in-place design. However, the accessory component 10 may be secured in place relative to the sealed enclosure 12 in any known manner.

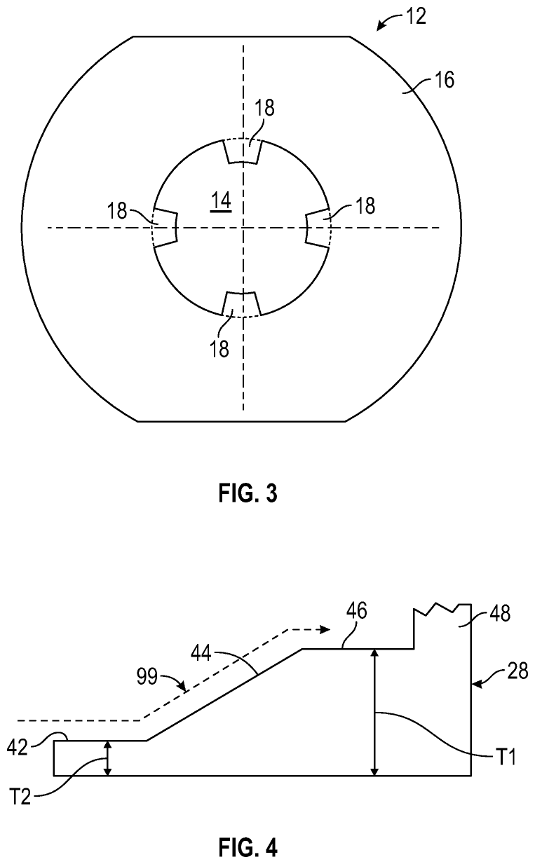

The accessory component 10 may be disposed within an opening 14 (best shown in FIGS. 1 and 3) formed through a wall 16 of the sealed enclosure 12. The wall 16 may include a plurality of mating flanges 18 configured for mounting the accessory component 10 to the wall 16 once received within the opening 14. The mating flanges 18 may protrude inwardly from a portion of the wall 16 that circumscribes the opening 14.

The accessory component 10 may include a body 20 and a mounting flange 22. The mounting flange 22 may be disk-shaped and may include a front surface 24 and a rear surface 26. When the accessory component 10 is mounted to the sealed enclosure 12, the rear surface 26 may face inwardly toward the wall 16, and the front surface 24 may face outwardly in a direction away from the wall 16.

The body 20 may protrude outwardly from the front surface 24 of the mounting flange 22. The body 20 may house subcomponents designed to perform one or more functions associated with the component to which the accessory component 10 is being mounted.

The accessory component 10 may include a plurality of cam tabs 28 for engaging the mating flanges 18 for fixedly mounting the accessory component 10 within the opening 14. The cam tabs 28 may protrude inwardly from the rear surface 26 of the mounting flange 22. The body 20 of the accessory component 10 and the cam tabs 28 may therefore protrude in opposite directions away from the mounting flange 22. In general, the total number of cam tabs 28 provided on the accessory component 10 is equal to the total number of mating flanges 18 provided on the wall 16 of the sealed enclosure 12.

The accessory component 10 may additionally include a plurality of indicator tabs 36 for visually indicating proper assembly of the accessory component 10 to the sealed enclosure 12. Each indictor tab 36 may protrude inwardly from the rear surface 26 of the mounting flange 22. The body 20 of the accessory component 10 and the indictor tabs 36 may therefore protrude in opposite directions away from the mounting flange 22 in a default position. In general, the total number of indictor tabs 36 provided on the accessory component 10 is equal to the total number of cam tabs 28 provided on the accessory component 10.

One indictor tab 36 may be located adjacent to each cam tab 28. In an embodiment, the indicator tabs 36 are positioned radially outward of the cam tabs 28 on the mounting flange 22.

Each indicator tab 36 may extend within an opening 38 (see FIG. 2) formed through the mounting flange 22 of the accessory component 10. Each indictor tab 36 may be connected at one end to the mounting flange 22 and may be unconnected the mounting flange 22 at the opposite end to establish a cantilevered design. Each connected end of the indictor tabs 36 may establish a fulcrum 40 (see FIG. 2) about which each indicator tab 36 may flex relative to the mounting flange 22. As further discussed below, the indicator tabs 36 may flex outwardly relative to the front surface 24 of the mounting flange 22 for visually indicating proper assembly of the accessory component 10 relative to the sealed enclosure 12.

A ring-like protrusion 30 may also protrude inwardly from the rear surface 26 of the mounting flange 22. The body 20 of the accessory component 10 and the ring-like protrusion 30 may therefore protrude in opposite directions away from the mounting flange 22. The ring-like protrusion 30 may be positioned radially between the cam tabs 28 and the indictor tabs 36.

A seal 32 may be received over the ring-like protrusion 30. The seal 32 may be configured to seal an interface between the accessory component 10 and the sealed enclosure 12. The seal 32 may be overmolded or bonded to the ring-like protrusion 30. In an embodiment, the seal 32 is a lip seal having a lip 34 designed to engage the mating flanges 18 when the accessory component 10 is fully secured in place relative to the sealed enclosure 12.

Each cam tab 28 may engage one of the mating flanges 18 in order to mount the accessory component 10 within the opening 14 of the wall 16 of the sealed enclosure 12. Each cam tab 28 may be designed to engage one of the mating flanges 18 of the sealed enclosure 12 prior to compression of the seal 32 and prior to engagement of the indicator tabs 36. As the accessory component 10 is moved (e.g., rotated) further into place, the cam tabs 28 may gradually compress the seal 32 and displace the indictor tabs 36 outwardly from the front surface 24 of the mounting flange 22 for providing a visual indictor of proper assembly (see right hand side of FIG. 1 for flexed indicator tab 36 that provides confirmation of proper assembly). If any one of the cam tabs 28 is not properly seated relative to its respective mating flange 18, the nearest adjacent indictor tab 36 will not protrude outwardly from the front surface 24, thereby indicting improper assembly.

FIG. 4, with continued reference to FIGS. 1-3, schematically illustrates a path 99 along which a mating flange 18 of the sealed enclosure 12 may travel as the accessory component 10 is moved into engagement with the sealed enclosure 12. During assembly, the mating flange 18 may first engage an outer plateau 42 of the cam tab 28. The mating flange 18 may then travel along an angled surface 44 of the cam tab 28. The angled surface 44 may connect the outer plateau 42 to an inner plateau 46 of the cam tab 28. The inner plateau 46 is located closer to a portion 48 of the cam tab 28 that is connected to the mounting flange 22 than the outer plateau 42. The mating flange 18 may subsequently travel along the inner plateau 46 where it becomes fully engaged relative to the cam tab 28. A first thickness T1 of the cam tab 28 at the inner plateau 46 may be greater than a second thickness T2 of the cam tab 28 as the outer plateau 42. The compressive force applied from the cam tab 28 to the mating flange 18 therefore increases as the mating flange 18 moves in the direction of the path 99.

Due at least in part to the angle of the angled surface 44, the seal 32 may be gradually compressed as the accessory component 10 is seated relative to the mating flanges 18, thereby causing the lip 34 of the seal 32 to firmly engage the wall 16 to seal the opening 14. As the compressive force increases, the indicator tab 36 nearest to the cam tab 28 is forced into firmer engagement with the wall 16, thereby triggering the indictor tab 36 to flex outwardly from a first or default position P1 (see left hand side of FIG. 1) to a second or flexed position P2 (see right hand side of FIG. 1). In the first position P1, the indicator tab 36 does not protrude outwardly of the front surface 24. However, in the second position P2, a portion of the indictor tab 36 protrudes outwardly of the front surface 24 (e.g., extends to a position that is proud of the front surface 24) and therefore is quickly and easily identifiable by an onlooker for providing visual indication of proper assembly.

Although a twist-in-place design is described above, other configurations are possible. For example, the accessory component 10 could alternatively provide a press-in-place design in which the indicator tabs 36 may flex outwardly to indicate proper assembly as the accessory component 10 is pressed further into engagement with the portion of the wall 16 that surrounds the opening 14 of the sealed enclosure 12.

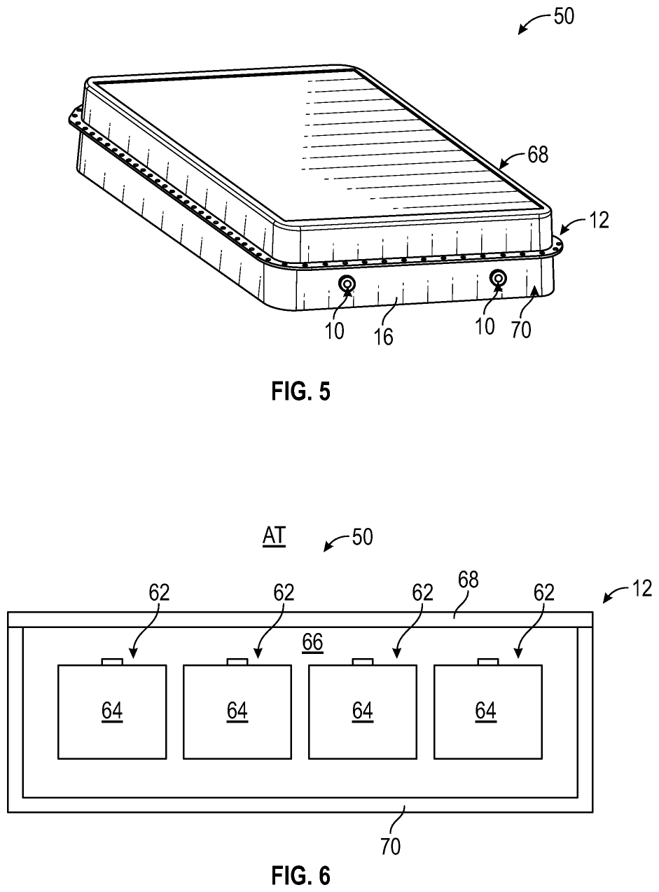

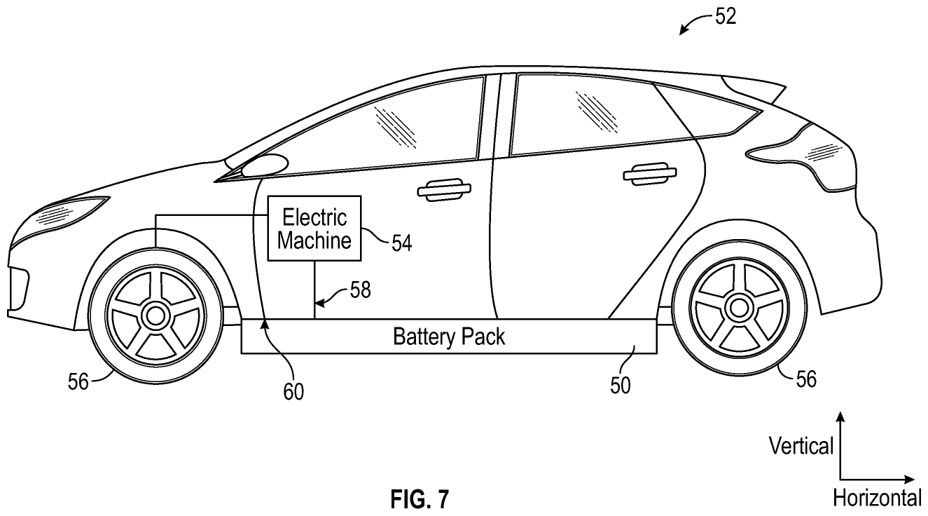

FIGS. 5, 6, and 7 illustrate an exemplary automotive component within which the accessory component 10 described above may be employed. In this implementation, the accessory component 10 is a pressure relief valve that may be mounted to a traction battery pack 50 of an electrified vehicle 52 (see FIG. 7). Again, however, other accessory components and other non-automotive implementations could benefit from the designs discussed above within the scope of this disclosure.

The electrified vehicle 52 may include any type of electrified powertrain. In the illustrated embodiment, the electrified vehicle 52 is a full electric vehicle propelled solely through electric power, such as by one or more electric machines 54, without assistance from an internal combustion engine. The electric machine 54 may operate as an electric motor, an electric generator, or both. The electric machine 54 receives electrical power and can convert the electrical power to torque for driving one or more wheels 56 of the electrified vehicle 52. A voltage bus 58 may electrically couple the electric machine 54 to the traction battery pack 50.

The traction battery pack 50 may be secured to an underbody 60 of the electrified vehicle 52. However, the traction battery pack 50 could be located elsewhere on the electrified vehicle 52 within the scope of this disclosure.

The traction battery pack 50 may be a high voltage traction battery pack system that includes one or more battery arrays 62 (e.g., battery assemblies or groupings of rechargeable battery cells 64) capable of outputting electrical power to power the electric machine 54 and/or other electrical loads of the electrified vehicle 52. Other types of energy storage devices and/or output devices could alternatively or additionally be used to electrically power the electrified vehicle 52.

The battery cells 64 may be stacked side-by-side along a stack axis to construct a grouping of battery cells, sometimes referred to as a “cell stack.” In the highly schematic depiction of FIG. 6, the battery cells 64 are stacked in a direction into the page to construct each battery array 62, and thus the battery arrays 62 may extend in cross-vehicle direction. However, other configurations may also be possible. The total number of battery arrays 62 and battery cells 64 provided within the traction battery pack 50 is not intended to limit this disclosure.

In an embodiment, the battery cells 64 of each battery array 62 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 62 and various other battery internal components (e.g., bussed electrical center, battery electric control module, wiring, connectors, etc.) may be housed within an interior area 66 of a sealed enclosure 12. The sealed enclosure 12 may include an enclosure cover 68 and an enclosure tray 70. The enclosure cover 68 may be secured (e.g., bolted, welded, adhered, etc.) to the enclosure tray 70 to provide the interior area 66. The size, shape, and overall configuration of the sealed enclosure 12 is not intended to limit this disclosure.

The traction battery pack 50 may include one or more of the accessory components 10. Each accessory component 10 may be mounted within the wall 16 of the sealed enclosure 12. The wall 16 may be part of the enclosure cover 68, the enclosure tray 70, or both. The exact mounting location of each accessory component 10 could vary and is therefore not intended to limit this disclosure.

In an exemplary implementation, each accessory component 10 may be configured to operate as a pressure relief valve. For example, the accessory component 10 may provide pressure equalization between the interior area 66 of the traction battery pack 50 and an atmosphere AT outside of the traction battery pack 50.

The exemplary accessory components of this disclosure include visual indicators for visually indicating proper assembly relative to a sealed enclosure of a receiving component. The solution ensures proper assembly without the need to perform additional leak tests subsequent to accessory component installation.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An assembly, comprising:
a sealed enclosure; and
an accessory component received within an opening formed through a wall of the sealed enclosure,
wherein an indicator tab of the accessory component is configured to flex between a first position and a second position for providing a visual indication that the accessory component is properly assembled relative to the sealed enclosure.

2. The assembly as recited in claim 1, wherein the assembly is a traction battery pack.

3. The assembly as recited in claim 1, wherein the accessory component is a pressure relief valve.

4. The assembly as recited in claim 1, wherein, in the second position, a portion of the indicator tab protrudes outwardly from a front surface of a mounting flange of the accessory component.

5. The assembly as recited in claim 4, wherein, in the first position, the portion does not protrude outwardly from the front surface.

6. The assembly as recited in claim 1, wherein the indicator tab is configured to flex between the first position and the second position as the accessory component is moved into further engagement with the wall.

7. The assembly as recited in claim 1, wherein a cam tab of the accessory component is configured to engage a mating flange of the wall to mount the accessory component to the sealed enclosure.

8. The assembly as recited in claim 7, wherein the cam tab includes an outer plateau, an inner plateau, and an angled surface that connects between the outer plateau and the inner plateau.

9. The assembly as recited in claim 8, wherein a first thickness of the cam tab at the inner plateau is greater than a second thickness of the cam tab at the outer plateau.

10. The assembly as recited in claim 1, wherein the accessory component includes a mounting flange having a ring-like protrusion, and further comprising a seal received over the ring-like protrusion and configured to seal against a portion of the wall when the accessory component is fully received within the opening.

11. An assembly, comprising:
a sealed enclosure;
an accessory component received within an opening formed through a wall of the sealed enclosure;
a cam tab of the accessory component is configured to engage a mating flange of the wall for mounting the accessory component to the sealed enclosure; and
an indicator tab of the accessory component is configured to move from a first position to a second position as the cam tab is moved into further engagement relative to the mating flange,
wherein the second position provides a visual indication that the accessory component is properly assembled relative to the sealed enclosure.

12. The assembly as recited in claim 11, wherein the assembly is a traction battery pack, and the accessory component is a pressure relief valve.

13. The assembly as recited in claim 11, wherein, in the second position, a portion of the indicator tab protrudes outwardly from a front surface of a mounting flange of the accessory component to provide the visual indication.

14. The assembly as recited in claim 13, wherein the front surface faces in a direction away from an interior of the sealed enclosure.

15. The assembly as recited in claim 11, wherein the cam tab includes an outer plateau, an inner plateau, and an angled surface that connects between the outer plateau and the inner plateau.

16. The assembly as recited in claim 15, wherein a first thickness of the cam tab at the inner plateau is greater than a second thickness of the cam tab at the outer plateau.

17. The assembly as recited in claim 11, wherein the accessory component includes a ring-like protrusion that protrudes from a mounting flange.

18. The assembly as recited in claim 17, comprising a seal received over the ring-like protrusion and configured to seal against a portion of the wall when the cam tab is moved into full engagement relative to the mating flange.

19. The assembly as recited in claim 18, wherein the seal is a lip seal.

20. The assembly as recited in claim 11, wherein the indicator tab is connected at one end to a mounting flange of the accessory component to establish a fulcrum about which the indicator tab can flex between the first position and the second position.
